(19) United States
(12) Patent Application Publication
(10) Pub. No.: US 2005/0289070 A1
(43) Pub. Date: Dec. 29, 2005

(54) Server providing computer resources to user terminals

(75) Inventors: Kouitirou Takahasi, Kawasaki (JP); Masaki Okuda, Kawasaki (JP); Shinya Shibata, Kawasaki (JP); Yoshiaki Watanabe, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/940,813

(22) Filed: Sep. 15, 2004

(30) Foreign Application Priority Data
May 31, 2004 (JP) 2004-161071

(51) Int. Cl. H02J 7/00

(52) U.S. Cl. 705/52

(57) ABSTRACT

Provided are a predetermined usage amount acquisition unit acquiring predetermined usage amount information within a predetermined period about the computer resources from the user terminals, a real usage amount calculation unit calculating real usage amount information indicating amount of actual usage of the user terminals within the predetermined period, and a charge calculation unit calculating, when calculating a charge imposed on the user terminals on the basis of the predetermined usage amount information and the real usage amount information, respectively a charge for a real usage amount equal to or larger than the predetermined usage amount and a charge for a real usage amount equal to or smaller than the predetermined usage amount in the whole usage amount by applying amount of money per different unit usage amount.

### BACKGROUND OF THE INVENTION

The present invention relates to an accounting processing technology for a computer resource.

There has hitherto existed a service for aggregating and managing processing contents of a variety of information processing equipment or of application software licenses, etc. on a server type center computer. In this type of service, the majority of users connect to the center computer via a network and utilize the process concerned.

In the case of thus aggregating the process at the center, a charge can be imposed on each individual user according to a usage amount of the each user. Namely, in this case, the individual users are impartially burdened with the service charge in accordance with their usage amounts.

By the way, in the case of administering the service for providing the information and the process through the center computer described above, the user might be asked to apply a prospective estimated usage amount (for, e.g., next one year) beforehand. With this pre-application, the service administrator can know a proper way of how to set an amount of equipment investment for the providing service.

Note that there is a technology disclosed in, e.g., the Document of “Japanese Patent Application Laid-Open No. 62-202261” as the prior art related to the invention of the present application.

The technology described above has, however, for example, the following problem.

To be specific, in the case of having the aforementioned estimated usage amount applied, it is necessary for the user to apply as accurate estimated usage amount as possible. It was not, however, easy for the user to calculate the accurate estimated usage amount. Therefore, in such a case, for example, the user often applied a rough estimated usage amount with some error from an actual usage amount.

Under a circumstance where the user applies the rough estimated usage amount as described above, it is considered that the user is not affected at all even when the estimated usage amount applied is different from the actual usage amount.

### SUMMARY OF THE INVENTION

The invention was devised in view of the items given above and aims at providing a technology capable of accurately grasping a usage amount of a user by making the user be aware of a service utilizing charge in an information providing process via a network.

The invention adopts the following means in order to solve the above problem. Namely, the invention is a server communicating with user terminals used by users and providing predetermined computer resources to the user terminals, comprising a predetermined usage amount acquisition unit acquiring predetermined usage amount information within a predetermined period about the computer resources from the user terminals, a real usage amount calculation unit calculating real usage amount information indicating amount of actual usage of the user terminals within the predetermined period, and a charge calculation unit calculating, when calculating a charge imposed on the user terminals on the basis of the predetermined usage amount information and the real usage amount information, respectively a charge for a real usage amount equal to or larger than the predetermined usage amount and a charge for a real usage amount equal to or smaller than the predetermined usage amount in the whole usage amount by applying amount of money per different unit usage amount.

According to the invention, a unit charge to be imposed differs depending on whether in excess of the predetermined usage amount of the server by each user. Namely, according to the invention, the charge to be calculated differs depending on whether in excess of the predetermined usage amount. Therefore, according to the invention, the user becomes to apply an accurate estimated usage amount in the server for providing the information.

Hence, according to the invention, in the computer resource providing service via the network, it is possible to provide the technology capable of accurately grasping the usage amount of the user by making the user be aware of the service utilizing charge.

Further, the invention is characterized in that the charge calculation unit sets amount of money per unit usage amount for the usage amount equal to or larger than the predetermined usage amount higher than amount of money per unit usage amount for the usage amount equal to or smaller than the predetermined usage amount.

Moreover, the invention is characterized in that the charge calculation unit sets, when the real usage amount is equal to or smaller than the predetermined usage amount, a predetermined fixed charge as the imposed charge, and calculates, when the real usage amount is equal to or larger than the predetermined usage amount, the imposed charge in proportion to the real usage amount.

Still further, the invention is characterized in that the charge calculation unit calculates, as the imposed charges, amount of charge obtained by multiplying the real usage amount by amount of money per first unit usage amount and amount of charge obtained by multiplying the predetermined usage amount by amount of money per second unit usage amount.

It should be noted that the invention may be a program for actualizing any of the functions given above. Further, the invention may also be a readable-by-computer storage medium stored with such a program. Yet further, the invention may also be an authentication storage device connected to the computer executing any of the functions given above and performing an authentication process for this computer.

As explained above, according to the invention, in the computer resource providing service via the network, it is possible to provide the technology capable of accurately grasping the usage amount of the user by making the user be aware of the service utilizing charge.

### BRIEF DESCRIPTION OF THE DRAWINGS

FIG. 1 is a view of an architecture of a computer-based computer resource content providing service system according to one embodiment of the invention;

FIG. 2 is a function block diagram of an application license management server;

FIG. 3 is an X-Y plane graph representing the formula and the formula;

FIG. 4 is a flowchart for calculating a charge by a first charge calculation method;

FIG. 5 is an X-Y plane graph representing the formula and the formula;

FIG. 6 is a flowchart for calculating a charge by a second charge calculation method;

FIG. 7 is an X-Y plane graph representing the formula and the formula;

FIG. 8 is a flowchart for calculating a charge by a third charge calculation method; and, FIGS. 9A and 9B is a chart showing an example of the charge calculation based on the first through third charge calculation methods in the embodiment.

### DESCRIPTION OF THE PREFERRED EMBODIMENTS

A preferred embodiment of the invention will hereinafter be described with reference to the drawings.

<System Architecture>

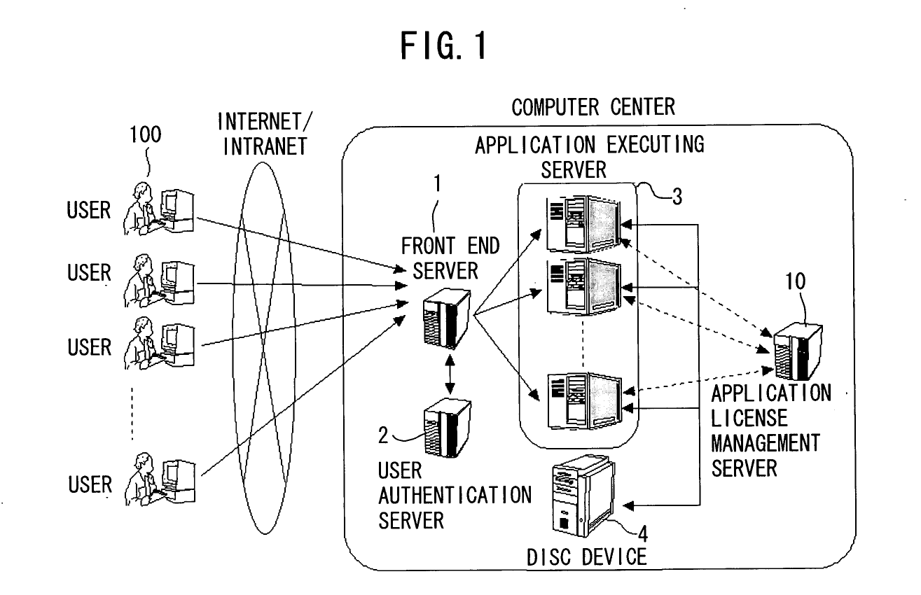

FIG. 1 is a view of an architecture of a computer-based computer resource content providing service system in one embodiment of the invention. The system includes a front end server 1 to which user terminals 100 of users who utilize this system are connected via a network (e.g., Internet). The system further includes a user authentication server 2 for authenticating the propriety of service utilization of the user terminal connected via the front end server 1.

Moreover, the system includes a predetermined number of application executing servers 3 for executing processes and applications provided to the users. These application executing servers 3 are connected to a disc device 4 constructed of a storage device such as a hard disc, etc. The application executing servers 3 transmit and receive application programs and data required for executing the processes to and from the disc device 4.

Further, the system includes an application license management server 10 corresponding to a server according to the present invention. The application license management server 10 is connected to the application executing servers 3. Moreover, the application license management server 10 manages a license (service utilizing authentication) for every user terminal 100 that utilizes the service. Furthermore, the application license management server 10 calculates a charge for utilizing the service on the basis of a predetermined estimated usage amount (predetermined usage amount) and an actual usage amount (real usage amount) with respect to every user who utilizes the service. It should be noted that the application license management server 10 has been exemplified by way of executing the charge calculation process as described above in the embodiment, however, the system may be configured so that the charge calculation process is executed actually in the front end server 1.

<Configuration of Application License Management Server>

Next, a configuration of the application license management server 10 will be explained.

The application license management server 10 is configured by use of a dedicated server machine or a computer such as a personal computer (PC), a workstation (WS) and so on. The application license management server 10 has, as pieces of hardware, control device (constructed of CPU, main memory (RAM, etc.), I/O unit, OS, device driver, etc.), secondary memory (hard disc, etc.), and communication control device (network interface device, etc.). Then, the CPU loads the program stored on the secondary memory into the main memory and then executes the program, whereby the application license management server 10 functions as the application license management server 10 corresponding to the server according to the invention, which will hereinafter be exemplified.

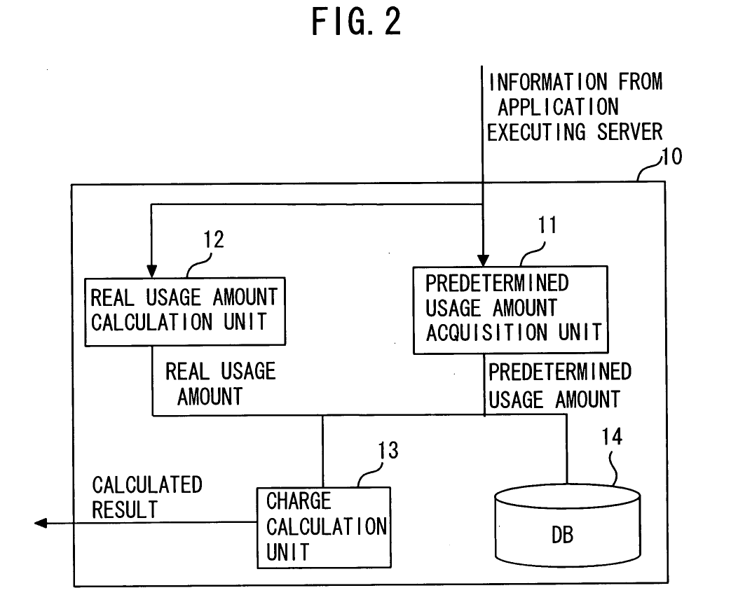

FIG. 2 is a function block diagram of the application license management server 10 actualized by the hardware architecture given above. The application license management server 10 includes a predetermined usage amount acquisition unit 11, a real usage amount calculation unit 12, a charge calculation unit 13 and a database 14.

The predetermined usage amount acquisition unit 11 acquires predetermined usage amount information within a predetermined usage period (e.g., one year or one month) from the user terminal 100. The real usage amount calculation unit 12 calculates real usage amount information indicating an actual usage amount of each individual user within the predetermined period on the basis of CPU usage information of the individual user in the application executing server 3, license usage information of the individual user in the application license management server, and disc area usage information of the individual user in the disc device. The charge calculation unit 13 calculates a charge imposed on the user using the user terminal 100 on the basis of the predetermined usage amount information and the real usage amount information. At this time, the charge calculation unit 13 calculates a charge for a real usage amount equal to or larger than (exceeding) the predetermined usage amount and a charge for a real usage amount equal to or smaller than the predetermined usage amount in the whole usage amount within the predetermined period in a way that applies an amount of money per different unit usage amount.

<Charge Calculation Method by Application License Management Server>

Next, a charge calculation method by the application license management server 10 will be explained with reference to formulae and flowcharts. Note that “X” represents information or a service usage amount (amount of processes) in the following formulae. It is considered as a basic unit charge is, for example, a charge per CPU usage time, a charge per hard disc unit storage quantity, or a license charge per required time of the application program, and so on. Further, “A” designates a basic unit charge in the following formulae. Moreover, “Y” represents a charge calculated based on X and A in the following formulae. Furthermore, “B” designates a numeric value of an extra of the unit charge in the following formulae. Still further, “C” designates a numeric value of a discount of the unit charge in the following formulae. Yet further, “Xm” designates a user's application value of the predetermined usage amount.

<First Charge Calculation Method>

According to a first charge calculation method, the charge is calculated by use of the following formula (1) and formula (2).
Y=AX(X≦Xm) Formula (1)
Y=AXm+(A+B) (X−Xm)=(A+B)X−BXm(X>Xm) Formula (2)

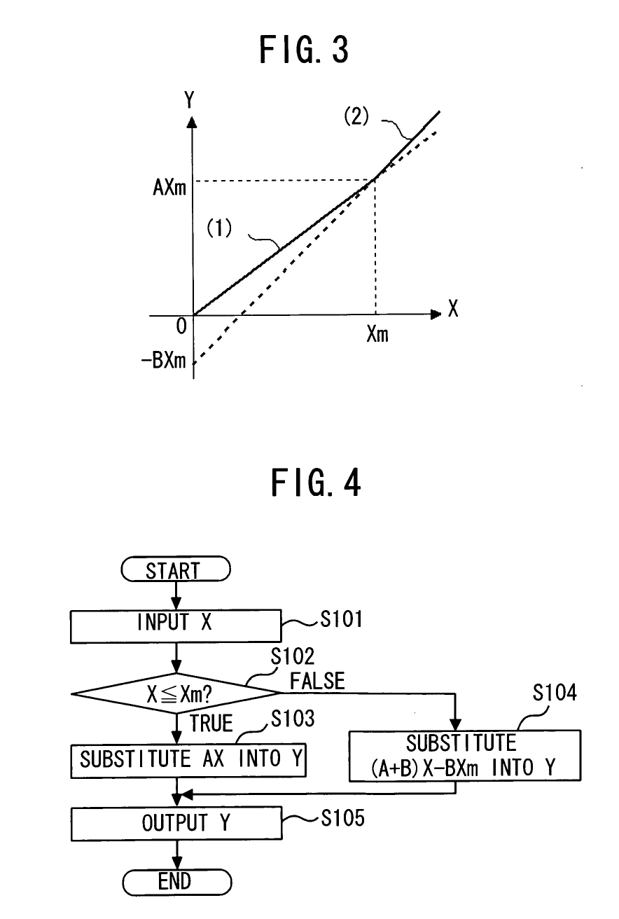

Further, FIG. 3 is an X-Y plane graph representing the formula (1) and the formula (2). To be specific, in the first charge calculation method, when a value of X ranges from 0 to Xm ((1) in FIG. 3), the charge calculation unit 13 calculates the charge Y in the formula (1). Moreover, when the value of X exceeds Xm ((2) in FIG. 3), the charge calculation unit 13 calculates the charge Y in the formula (2).

FIG. 4 is a flowchart for calculating the charge by the first charge calculation method. To start with, the charge calculation unit 13 inputs a value of the usage amount X acquired from the real usage amount calculation unit 12 (S101). Next, the charge calculation unit 13 judges whether or not the “X” is equal to or smaller than the predetermined estimated usage amount (the predetermined usage amount) Xm applied by the user (S102).

In the process in S102, when the value of X is equal to or smaller than Xm, the charge calculation unit 13 substitutes AX into Y, thereby obtaining the charge Y (S103). Further, in the process in S102, when the value of X exceeds Xm, the charge calculation unit 13 substitutes (A+B)X−BXm into Y, thereby obtaining the charge Y (S104). Then, the charge calculation unit 13 outputs the thus-calculated charge Y (S105).

The first charge calculation method in the embodiment discussed above is processed in such a way that the function of the charge calculation unit 13 is actualized by the CPU in the application license management server 10 in the embodiment and by an accounting program stored on the storage device (e.g., the hard disc, etc.). Namely, the CPU of the application license management server 10 reads the usage amount from the storage device stored with the usage amount. Thereafter, the CPU stores the main memory (memory) with a value corresponding to a variable X. Then, the CPU multiplies a stored-on-the-main-memory value corresponding to the variable X by a stored-on-the-main-memory value corresponding to a coefficient A. The application license management server 10 can calculate the charge Y by executing such processes.

Thus, the service utilizing charge of the user is calculated by the first charge calculation method, whereby a service administrator can charge the user, whose usage amount exceeds the applied usage amount, for an extra charge. Then, owing to the thus-set service utilizing charge, the user tries to utilize the service so as to be equal or less than the pre-applied usage amount. Therefore, the application license management server 10 having executed the first charge calculation method is capable of accurately grasping a data usage amount of the user in the computer resource providing service via the network.

<Second Charge Calculation Method>

According to a second charge calculation method, the charge is calculated by use of the following formula (3) and formula (4).
Y=AXm(X≦Xm) Formula (3)
Y=(A+B)X−BXm(X>Xm) Formula (4)

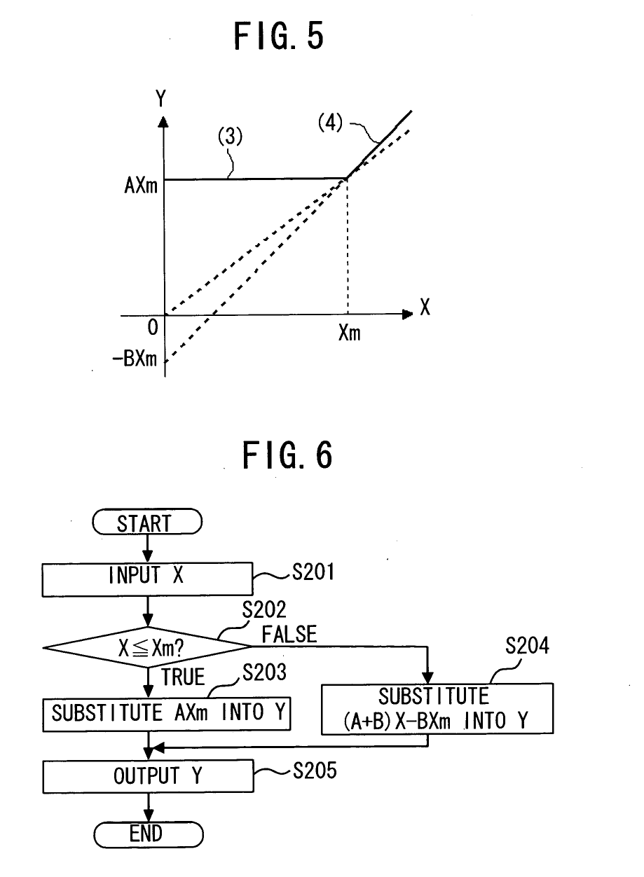

Further, FIG. 5 is an X-Y plane graph representing the formula (3) and the formula (4). Specifically, in the second charge calculation method, when a value of X ranges from 0 to Xm ((3) in FIG. 5), the charge calculation unit 13 calculates the charge Y in the formula (3). Moreover, when the value of X exceeds Xm ((4) in FIG. 5), the charge calculation unit 13 calculates the charge Y in the formula (4).

FIG. 6 is a flowchart for calculating the charge by the second charge calculation method. Different points between the flowchart of the second charge calculation method and the flowchart of the first charge calculation method, are steps S203 and S204 for substitutions in the formulae. Therefore, An explanation of only the different points in the flowchart of the second charge calculation method from the flowchart of the first charge calculation method will be explained.

In the process in S202, when the value of X is equal to or smaller than Xm, the charge calculation unit 13 substitutes a value of AXm into Y, thereby obtaining the charge Y (S203). Further, in the process in S202, when the value of X exceeds Xm, the charge calculation unit 13 substitutes (A +B) X−BXm into Y, thereby obtaining the charge Y (S204). Then, the charge calculation unit 13 outputs the calculated charge Y (S205). Note that the application license management server 10 also in the second charge calculation method calculates the charge Y by executing the same processes as those in the first charge calculation method described above.

Thus, the service utilizing charge of the user is calculated by the second charge calculation method, whereby a service administrator can charge the user, whose usage amount exceeds the applied usage amount, for an extra charge. Further, the service utilizing charge of the user is calculated by the second charge calculation method, whereby the service administrator can offer a fixed service charge to the user showing the usage amount equal to or less than the applied usage amount. Then, the service utilizing charge is thus set, and consequently the user tries to utilize the service with the usage amount equal to or less than the pre-applied usage amount. Hence, the application license management server 10 having executed the second charge calculation method is capable of accurately grasping a data usage amount of the user in the computer resource providing service via the network.

<Third Charge Calculation Method>

According to a third charge calculation method, the charge is calculated by use of the following formula (5) and formula (6).
Y=AXm−(A−C) (Xm−X)=(A−C)X+CXm(X≦−Xm) Formula (5)
Y=(A+B)X−BXm(X>Xm) Formula (6)

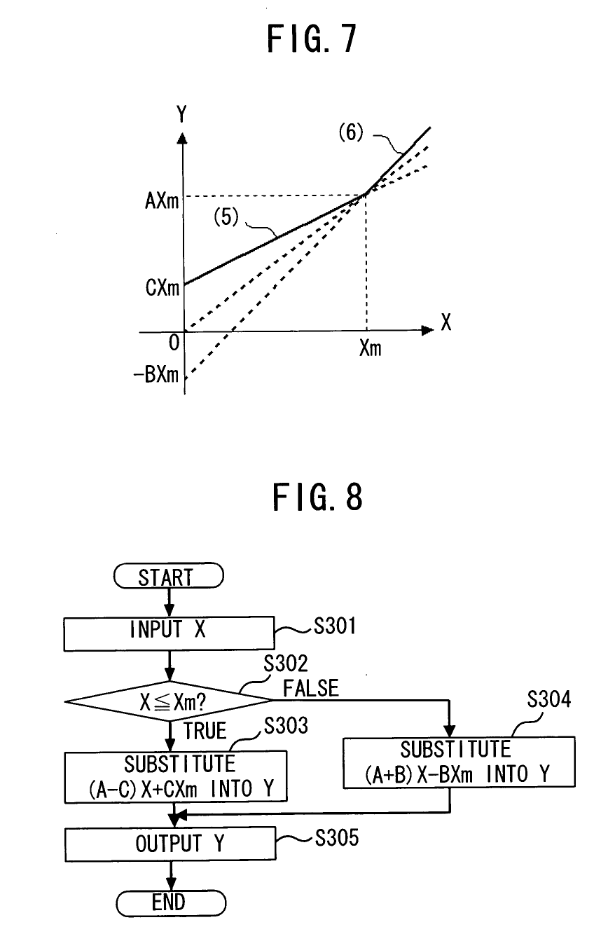

Further, FIG. 7 is an X-Y plane graph representing the formula (5) and the formula (6). Specifically, in the third charge calculation method, when a value of X ranges from 0 to Xm ((5) in FIG. 7), the charge calculation unit 13 calculates the charge Y in the formula (5). Moreover, when the value of X exceeds Xm ((6) in FIG. 7), the charge calculation unit 13 calculates the charge Y in the formula (6).

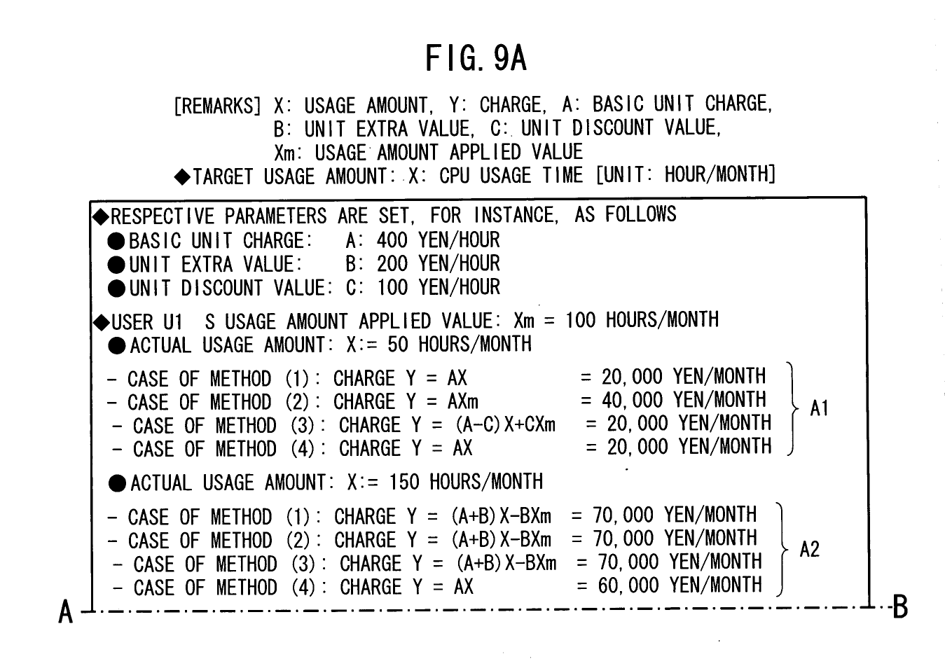

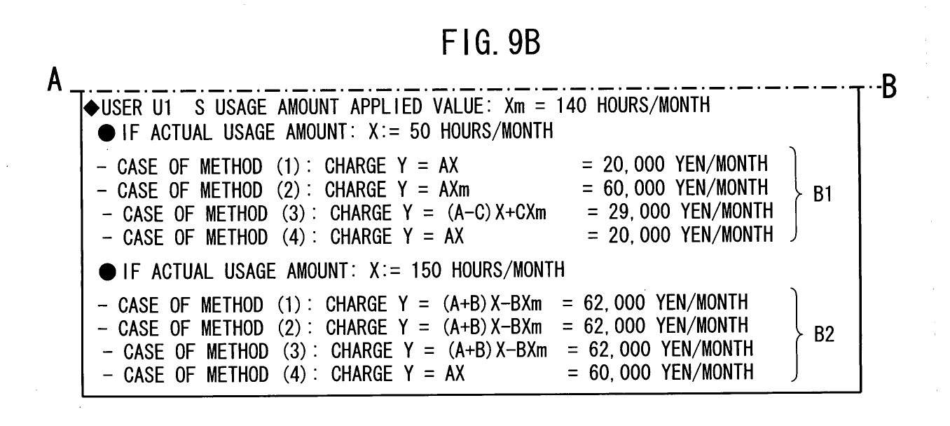

FIG. 8 is a flowchart for calculating the charge by the third charge calculation method. Different points between the flowchart of the third charge calculation method and the flowchart of the first charge calculation method, are steps S303 and S304 for substitutions in the formulae. Therefore, An explanation of only the different points in the flowchart of the third charge calculation method from the flowchart of the first charge calculation method will be explained.

In the process in S302, when the value of X is equal to or smaller than Xm, the charge calculation unit 13 substitutes a value of (A−C)X+CXm into Y, thereby obtaining the charge Y (S303). Further, in the process in S304, when the value of X exceeds Xm, the charge calculation unit 13 substitutes (A+B) X−BXm into Y, thereby obtaining the charge Y (S304). Then, the charge calculation unit 13 outputs the thus-calculated charge Y (S305). Note that the application license management server 10 also in the third charge calculation method calculates the charge Y by executing the same processes as those in the first and second charge calculation methods described above.

Thus, the service utilizing charge of the user is calculated by the third charge calculation method, whereby a service administrator can charge the user, whose usage amount exceeds the applied usage amount, for an extra charge. Further, the service utilizing charge of the user is calculated by the third charge calculation method, whereby the service administrator can offer a service charge changed in proportion to the usage amount to the user showing the usage amount equal to or less than the applied usage amount. Then, the service utilizing charge is thus set, and consequently the user tries to utilize the service with the usage amount equal to or less than the pre-applied usage amount. Therefore, the application license management server 10 having executed the third charge calculation method is capable of accurately grasping a data usage amount of the user in the computer resource providing service via the network.

<Example of Charge Calculation>

Next, an example of the charge calculation based on the first through third charge calculation methods described above, will be explained.

FIGS. 9A and 9B is a chart showing the example of the charge calculation based on the first through third charge calculation methods in the embodiment. This chart shows the formulae together for calculating the charges in proportion to only the usage amounts irrespective of the hitherto-applied usage amounts for comparisons.

In FIGS. 9A and 9B, the first charge calculation method is set as a method (1). Further, the second charge calculation method is set as a method (2). Still further, the third charge calculation method is set as a method (3). Yet further, the aforementioned conventional method is set as a method (4).

It is understood from FIGS. 9A and 9B that when looking at A1, B1 exhibiting usage amounts equal to or less than the applied predetermined usage amounts per month and A2, B2 exhibiting usage amounts equal to or larger than the predetermined usage amounts in comparison with the conventional method (4), charges are added in a case where the actual usage amounts exceed. Thus, it is possible to calculate the extra charges imposed on the users who utilized the service with the usage amount equal to or larger than the predetermined estimated usage amounts by calculating the service utilizing charges by using the charge calculation methods according to the embodiment. Accordingly, the charge calculation methods according to the embodiment are employed, thereby enabling the service administrator to accurately grasp the service usage amounts by indicating these charge calculation methods to the users.

<Comparison between Charge Calculation Methods>

Next, there is conducted a comparison between the above three charge calculation methods by the application license management server 10 in the embodiment.

At first, according to the first charge calculation method, the unit usage charge differs depending on whether the usage amount exceeds the applied value or not. Then, the first charge calculation method, by which the unit charge rises when the usage amount exceeds the applied value, is therefore capable of promoting the user to utilize the service within the range of the applied value.

Moreover, according to the first charge calculation method, even if within the range of the applied value, the charge is imposed in proportion to the usage amount. Therefore, the user, even after applying once the usage amount, can restrain the user himself or herself from unnecessarily utilizing the system. Namely, according to the first charge calculation method, the service (system) administrator is able to accurately grasp the usage amount of the service.

In the first charge calculation method, however, none of a load is applied on the user even when increasing the applied value itself. Accordingly, In the first charge calculation method, it is considered that the user might estimate a comparatively large usage amount and might thus apply the usage amount.

Next, according to the second charge calculation method, when comparing with the case in which the basic unit charge is fixed as in the prior art, the charge rises as the usage amount exceeds the applied value. Hence, the second charge calculation method is capable of prompting the user to utilize the service within the range of the applied value. Further, the second charge calculation method is capable of prompting the user to set the applied value taking the computer resources (throughput) into consideration.

In the second charge calculation method, however, the charge remains fixed till the usage amount reaches the applied value. Therefore, the user, after once giving the applied value, tends to utilize the service in a carefree manner even if unnecessary for utilizing it. Namely, the user comes to have a tendency of deciding that the service should be utilized to its upper limit after once applying the value. Hence, according to the second charge calculation method, there is a possibility that the user will utilize the service unnecessarily.

Next, according to the third charge calculation method, the unit usage charge differs anterior and posterior to the applied value. Further, according to the third charge calculation method, even when the usage amount is 0, CXm defined as an initial cost proportional to the applied value (Xm) is required.

Moreover, in the third charge calculation method, when the usage amount exceeds the applied value, the unit usage charge increases. Accordingly, the third charge calculation method is capable of restraining the user from utilizing in excess over the applied value as in the case of the first charge calculation method.

On the other hand, in the third charge calculation method, the initial cost proportional to the applied value occurs, and hence it follows that the user is to precisely calculate the estimated amount of money. Moreover, according to the third charge calculation method, even when equal to or less than the applied value, the charge rises as the usage amount increases. Therefore, the third charge calculation method can restrain the user from the use carefree enough to utilize to the upper limit of the set usage amount within the range of the once-applied value.

1. A server communicating with user terminals and providing predetermined computer resources to the user terminals, comprising:
a predetermined usage amount acquisition unit acquiring predetermined usage amount information within a predetermined period about the computer resources from the user terminals;
a real usage amount calculation unit calculating real usage amount information indicating amount of actual usage of the user terminals within the predetermined period; and
a charge calculation unit calculating, when calculating a charge imposed on the user terminals on the basis of the predetermined usage amount information and the real usage amount information, respectively a charge for a real usage amount equal to or larger than the predetermined usage amount and a charge for a real usage amount equal to or smaller than the predetermined usage amount in the whole usage amount by applying amount of money per different unit usage amount.

2. A server according to claim 1, wherein said charge calculation unit sets amount of money per unit usage amount for the usage amount equal to or larger than the predetermined usage amount higher than amount of money per unit usage amount for the usage amount equal to or smaller than the predetermined usage amount.

3. A server according to claim 1, wherein said charge calculation unit sets, when the real usage amount is equal to or smaller than the predetermined usage amount, a predetermined fixed charge as the imposed charge, and calculates, when the real usage amount is equal to or larger than the predetermined usage amount, the imposed charge in proportion to the real usage amount.

4. A server according to claim 1, wherein said charge calculation unit calculates, as the imposed charges, amount of charge obtained by multiplying the real usage amount by amount of money per first unit usage amount and amount of charge obtained by multiplying the predetermined usage amount by amount of money per second unit usage amount.

5. An accounting program for making a computer communicating with user terminals and providing predetermined computer resources to the user terminals, the program comprising steps of:
acquiring predetermined usage amount information within a predetermined period about the computer resources from the user terminals;
calculating real usage amount information indicating an amount of actual usage of the user terminals within the predetermined period; and
calculating, when calculating a charge imposed on the user terminals on the basis of the predetermined usage amount information and the real usage amount information, respectively a charge for a real usage amount equal to or larger than the predetermined usage amount and a charge for a real usage amount equal to or smaller than the predetermined usage amount in the whole usage amount by applying amount of money per different unit usage amount.

6. An accounting program according to claim 5, wherein said charge calculation step involves setting amount of money per unit usage amount for the usage amount equal to or larger than the predetermined usage amount higher than amount of money per unit usage amount for the usage amount equal to or smaller than the predetermined usage amount.

7. An accounting program according to claim 5, wherein said charge calculation step involves setting, when the real usage amount is equal to or smaller than the predetermined usage amount, a predetermined fixed charge as the imposed charge, and calculating, when the real usage amount is equal to or larger than the predetermined usage amount, the imposed charge in proportion to the real usage amount.

8. An accounting program according to claim 5, wherein said charge calculation step involves calculating, as the imposed charges, amount of charge obtained by multiplying the real usage amount by amount of money per first unit usage amount and amount of charge obtained by multiplying the predetermined usage amount by amount of money per second unit usage amount.

9. An accounting method for making a computer communicating with user terminals and providing predetermined computer resources to the user terminals, the method comprising the steps of:
acquiring predetermined usage amount information within a predetermined period about the computer resources from the user terminals;
calculating real usage amount information indicating amount of actual usage of the user terminals within the predetermined period; and
calculating, when calculating a charge imposed on the user terminals on the basis of the predetermined usage amount information and the real usage amount information, respectively a charge for a real usage amount equal to or larger than the predetermined usage amount and a charge for a real usage amount equal to or smaller than the predetermined usage amount in the whole usage amount by applying amount of money per different unit usage amount.

10. An accounting method according to claim 9, wherein said charge calculation step involves setting amount of money per unit usage amount for the usage amount equal to or larger than the predetermined usage amount higher than amount of money per unit usage amount for the usage amount equal to or smaller than the predetermined usage amount.

11. An accounting method according to claim 9, wherein said charge calculation step involves setting, when the real usage amount is equal to or smaller than the predetermined usage amount, a predetermined fixed charge as the imposed charge, and calculating, when the real usage amount is equal to or larger than the predetermined usage amount, the imposed charge in proportion to the real usage amount.

12. An accounting method according to claim 9, wherein said charge calculation step involves calculating, as the imposed charges, amount of charge obtained by multiplying the real usage amount by amount of money per first unit usage amount and amount of charge obtained by multiplying the predetermined usage amount by amount of money per second unit usage amount.
